(19) United States
(12) Patent Application Publication
(10) Pub. No.: US 2007/0091920 A1
(43) Pub. Date: Apr. 26, 2007

(54) System and method for improving the capacity of a network

(76) Inventors: John M. Harris, Chicago, IL (US); Hua Xu, Lake Zurich, IL (US)

Correspondence Address: MOTOROLA, INC., 1303 EAST ALGONQUIN ROAD, IL01/3RD, SCHAUMBURG, IL, 60196, US

(21) Appl. No.: 11/254,267

(22) Filed: Oct. 20, 2005

(51) Int. Cl. H04J 3/22

(52) U.S. Cl. 370/468

(57) ABSTRACT

At lease one operating condition associated with an end user (120) of a network is obtained. Based upon the operating condition, a high bit-rate media feed being made to the end user (120) is halted. Thereafter, a lower bit rate media feed may be supplied to the end user in place of the high bit-rate media feed.

### FIELD OF THE INVENTION

The field of the invention relates to mobile stations in networks and communications made to these mobile stations.

### BACKGROUND OF THE INVENTION

Mobile stations operate in communication networks and provide various types of services to users. For example, video and audio streaming services are often offered to users of mobile stations. In video streaming, an effectively continuous stream of video images is provided to users of the mobile stations so that these users may view movies, television programming or conference calls in substantially real time, to give a few examples. In audio streaming, a stream of audio packets may be sent to the user to provide, for instance, similar services for music or radio programming services.

Streaming audio and video consumes significant amounts of system capacity. However, having a high system capacity is needed in many applications such as Push-to-View, video clips, TV sports, radio, video monitoring, group call, multimedia Push-to-Talk (PTT), and net meeting applications. Streaming video and audio contain a number of flexible dimensions, which in previous systems were insensitive to system loading and the Radio Frequency (RF) conditions of a mobile station. Resource usage also varied widely among mobile stations.

The ability to provide these services to the mobile stations and the quality of these services may depend upon operating conditions of the network. For instance, a mobile station may operate at the edge of a coverage area, and experience poor radio frequency (RF) operating conditions. When the mobile station experiences these poor operating conditions, the media services provided to the user may be terminated or the Quality-of-Service (QoS) may become degraded.

Unfortunately, previous systems did not tend to consider the operating conditions of the network when providing media services to users. Consequently, as operating conditions of the mobile station deteriorated, poor or dropped coverage frequently occurred. Due to these problems, important communications were sometimes lost and user frustration often resulted.

### BRIEF DESCRIPTION OF THE DRAWINGS

FIG. 1 is a block diagram of an apparatus for increasing system capacity according to the present invention;

FIG. 2 is a flow chart showing a method for increasing system capacity according to the present invention; and

FIG. 3 is a call-flow diagram showing one approach for increasing system capacity according to the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE PREFERRED EMBODIMENTS

A system and method are provided whereby a high-rate media feed is replaced, at least temporarily, by a lower bit-rate media feed such as a lower bit-rate video or audio feed. By selectively replacing the high-bit rate media feed with a lower bit-rate media feed, system capacity can be increased.

In many of these embodiments, at lease one operating condition associated with an end user of a network is obtained. Based upon the operating condition, a high bit-rate media feed being provided to the end user is halted. Thereafter, a lower bit rate media feed may be supplied to the end user in place of the high bit-rate media feed. In one example, a high bit-rate media feed is halted whenever consistently poor Radio Frequency (RF) operating conditions are detected.

Any number of operating conditions can be obtained and evaluated. For example, these conditions may include RF operating conditions, system load conditions, battery life conditions, signal strength conditions, or mobility conditions. Other examples of conditions are possible.

In addition, the lower bit-rate media may include media of various forms and formats. For example, this media may include commercial advertisements, highlight video clips, replay video clips, music that is currently available at the mobile station, slides, video Extensible Markup Language (XML) streams having a lower bit-rate, media having less strict audio or motion thresholds, preloaded educational media, or media with a reduced amount of feature changes. Other examples of lower bit-rate media are possible.

The lower bit-rate media may be from different sources as well. For example, the lower bit-rate media may be selected from multiple media streams or may be a single stream.

In addition to choosing a different lower bit-rate media, other approaches can be used to reduce the speed or other characteristics of the media being provided to a user. For instance, the rate of a play-out buffer at the mobile station of the end user may be slowed.

Thus, approaches are provided that increase system capacity by replacing a high bit-rate media feed with a lower bit-rate media feed when operating conditions are at a predetermined level or value. The approaches described herein enhance the user experience and speed the presentation of various types of media to end users.

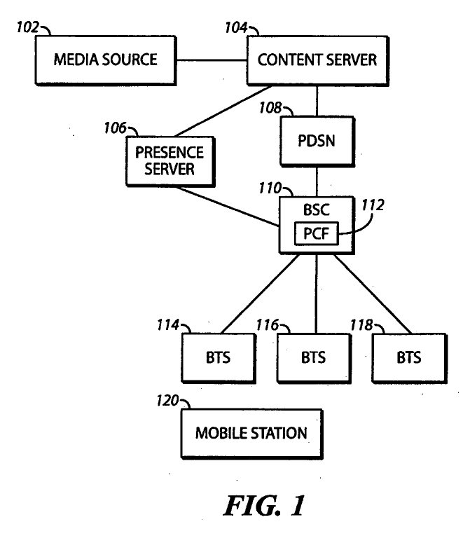

Referring now to FIG. 1, one example of a system for increasing system capacity is described. A media source 102 is coupled to a content server 104. The content server 104 is coupled to a Packet Data Serving Node (PDSN) 108 and a presence server 106. A Base Station Controller (BSC) 110 (including a packet control function 112) is coupled to the PDSN 108, presence server 106, and Base Transceiver Stations (BTSs) 114, 116 and 118. The BTS 114 is communicatively coupled to a mobile station 120.

The media source 102 may be a service, device, or combination of services or devices that provide media services. For example, the media source may provide high bit-rate video, commercial advertisements, highlight video clips, replay video clips, audio, music, slides, video XML streams, media with various audio and motion thresholds (e.g., from security cameras), educational media, media with a reduced amount of feature changes, or any other type of media. The media may be provided in a single or multiple media streams.

The content server 104 determines where to supply the media. The content server 104 also receives and evaluates operating conditions and determines the type of media to provide based upon these operating conditions. Alternatively, the functionality may be provided at clients of the server 104 (e.g., the mobile stations).

The PDSN 108 provides switching functions in the network. The presence server 106 provides presence information concerning whether a user is available or unavailable. The BSC 110 routes communications to and from various BTSs. The PCF 112 provides for control and processing of packets.

The BTSs 114, 116 and 118 provide functionality that allows communications to occur between the BSC 110 and mobile stations. For example, the BTSs 114, 116 and 118 may include base stations, receivers and transmitters or other types of equipment to support these functions.

In one example of the operation of system of FIG. 1, at least one operating condition associated with an end user associated with the mobile station 120 is obtained by the content server 104. Based upon the operating condition, a high bit-rate media feed being made to the end user 120 from the media source 102 is halted by the content server 104. Thereafter, a lower bit rate media feed may be supplied to the end user at the mobile station 120 in place of the high bit-rate media feed. In one example, a high bit-rate media feed is halted by the content server 104 whenever consistently poor Radio Frequency (RF) operating conditions are detected by the BTSs 114, 116, and 118.

The RF operating conditions may be determined using a number of approaches. For example, the number of bars on the display of a mobile station may be used as an indication of the operating conditions. Further, the number of legs of a software handoff, a higher mobility, a best average estimate for an interval prior to the next decision, or a poor Eb/io ratio may be used as indications of the operating conditions. Other examples of approaches to determine operating conditions are possible.

The lower bit rate media feed may be any number of different types of media. For example, low-bit rate commercials may be used. In another example, slides may be substituted for the high bit-rate video. In another example, music that is already at a mobile station may be used. In still another example, background music may be used. In another example, if video is being received from a camera, then the amount of camera angle, location, or zoom changes may be reduced or eliminated. In another example, the frame offsets may be staggered. Other examples are possible.

In another example, when the media source 102 is transmitting high bit rate video to an end user, the conditions of any link may be examined. If the conditions deteriorate on the link, the media may be switched to low bit-rate media.

An operator can control how dramatically the sequence of video is impacted by the RF conditions by adjusting a parameter or malleability knob. If the knob is set to be more malleable, then the user may observe a longer sequence of low bit rate media (e.g., commercials) when in poor RF conditions. When the knob is set to be less malleable, then after a period of time (e.g., a few commercials), the video may resume even though the mobile station is experiencing poor RF conditions.

In another example, the source 102 may be a wireless video server that receives video streams from many sources. Each video stream may receive a priority or Quality-of-Service (QoS) indicator. The video server may select the highest priority feed. In another approach, when many RF conditions are good, but some RF conditions are worse, the number of camera changes (e.g., angle, location, and zoom changes) may be reduced.

When a call is dropped, different media may be presented to a user. For example, when a call is dropped, the user may be given an opportunity to use a wireless video game for free to compensate the user for the dropped call. Other examples of substitutions are possible.

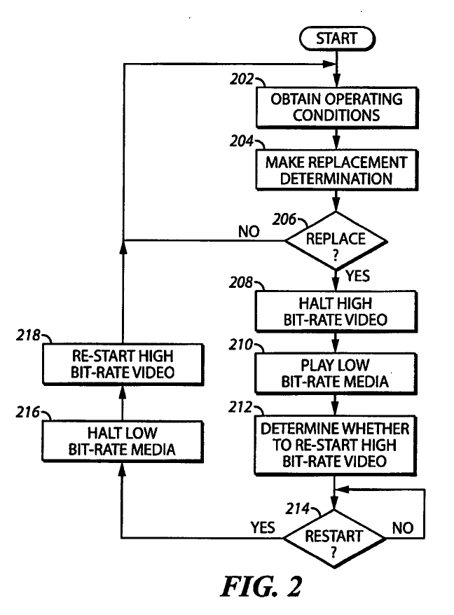

Referring now to FIG. 2, one example of an approach for increasing the system capacity of a network is described. At step 202, operating conditions are obtained. These may be obtained from different sources, for example, from base stations in a Radio Access Network (RAN). At step 204, a determination is made as to whether to replace a high bit-rate media feed with a lower bit-rate media feed. For example, the RF operating conditions may be evaluated and compared to a threshold. When the quality is below the threshold, then the high bit-rate video feed may be replaced by a lower bit-rate media feed. A determination may also be made as to the characteristics or source of the lower bit-rate media feed.

At step 206, it is determined whether an affirmative decision has been made to replace the high bit-rate media feed being supplied to the mobile station. If the answer is negative, execution continues at step 202. If the answer is affirmative, control continues with step 208.

At step 208, the high bit-rate media stream being supplied to the target mobile station is halted. At step 210, a lower bit-rate media feed begins to be supplied to the target mobile station. At step 212, it is determined whether to re-start the high bit-rate media feed to the target mobile station. For example, the conditions may be re-evaluated and determined to have improved or a predetermined period of time may have passed. If the answer is negative, control returns to step 214 where the lower bit-rate media feed continues to be supplied to the target mobile station.

If the answer and step 214 is affirmative, at step 216, the lower bit-rate media is halted. At step 218, the high bit-rate media stream is re-started and again supplied to the target mobile station. Execution returns to step 202 as described above.

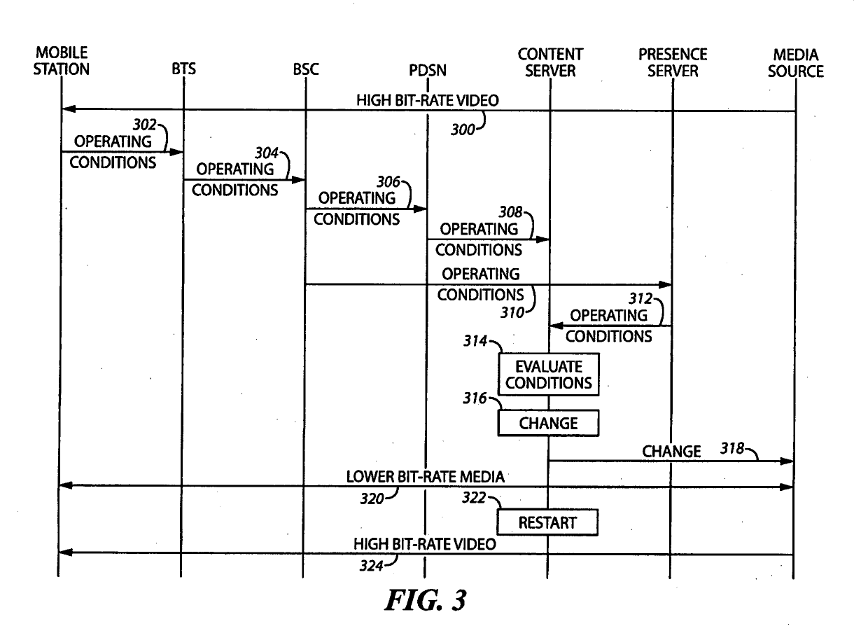

Referring now to FIG. 3, one example of an approach for increasing system capacity is described. At step 300, a high bit-rate media stream is established between a media server and a mobile station. At step 302, operating conditions are reported from the mobile station to the BTS. At step 304, the operating conditions are forwarded from the BTS to the BSC, at step 306, from the BSC to the PDSN, and at step 308, from the PDSN to the content server. These operating conditions may include RF operating conditions as measured by the mobile station or by a Radio Access Network (RAN).

At step 310, operating conditions may be forwarded from the BSC to the presence server and at step 312, from the presence server to the content server. In one example, these operating conditions may indicate RF operating conditions measured at the BSC.

At step 314, the content server evaluates the operating conditions. For example, the operating conditions may be compared to thresholds. At step 316, a determination is made as to whether to change the high bit-rate media stream being supplied to the mobile station to a lower bit-rate media stream.

In this case, at step 318, a determination is made to change and a change message is sent to the media server. At step 320, a lower bit-rate media stream is established between the media server and the mobile station.

At step 322, it is determined by the content server whether to return supplying the high bit-rate media to the target mobile station. For example, an evaluation may be based upon newly observed operating conditions. In another example, a pre-determined period of time may have expired. At step 324, the high bit-rate media stream is re-established between the media server and the mobile station.

Thus, approaches are described that increase system capacity by substituting a lower bit-rate media stream for a high bit-rate media stream to the mobile station when dictated by operating conditions in the network. Consequently, the user experience is enhanced since the number of dropped and poor quality calls are reduced or eliminated and user frustration is also reduced.

Those skilled in the art will recognize that a wide variety of modifications, alterations, and combinations can be made with respect to the above described embodiments without departing from the broad scope of the invention, and that such. modifications, alterations, and combinations are to be viewed as being within the scope of the invention.

What is claimed Is:

1. A method of increasing performance of a network comprising the steps of:
obtaining at least one operating condition associated with an end user in a network;
supplying a high bit-rate media feed to the end user; and
based upon the at least one operating condition, selectively halting the supplying of the high bit-rate media feed to the end user and thereafter supplying for at least a predetermined amount of time a lower bit-rate media feed to the end user instead of the high bit-rate media feed.

2. The method of claim 1 further comprising the step of halting the lower bit-rate media feed and conditionally restarting the high bit-rate media feed.

3. The method of claim 1 wherein obtaining the at least one operating condition comprises obtaining at least one operating condition selected from a group comprising: a Radio Frequency (RF) condition; a system load condition; a battery life condition of a mobile station; a signal strength condition; and a mobility condition.

4. The method of claim 1 wherein supplying a lower bit-rate media feed comprises supplying a media to the end user, the media selected from a group comprising: a commercial advertisement; a highlight video clip; a replay video clip; currently available music; a slide; a video Extensible Markup Language (XML) stream having a lower bit rate; a media having a less strict audio threshold; a media having a less strict motion threshold; a preloaded educational media; and a media with a reduced amount of feature changes.

5. The method of claim 1 wherein supplying a low bit-rate media feed comprises slowing a play-out rate of media from a play-out buffer.

6. The method of claim 1 further comprising the step of selecting the lower bit-rate media between multiple media streams.

7. The method of claim 1 wherein halting the high bit-rate media feed comprises only halting the high bit-rate media feed when consistently poor RF conditions are detected.

8. A method of improving system performance comprising the steps of:
determining a quality of a Radio Frequency (RF) connection supplying a high bit-rate media feed to an end user; and
whenever the quality is determined to be below a threshold, adjusting at least one characteristic of the high bit-rate media feed to improve the quality.

9. The method of claim 8 wherein determining a quality comprises evaluating an operating condition, the operating condition being selected from a group comprising: a system loading condition; a Radio Frequency (RF) condition; a battery life condition of a mobile station; a signal strength condition; and a mobility condition.

10. The method of claim 8 wherein adjusting at least one characteristic comprises adjusting an operating characteristic of a security camera to improve quality.

11. The method of claim 8 wherein adjusting at least one characteristic comprises replacing the high bit-rate media feed with a low bit-rate media feed.

12. The method of claim 11 wherein supplying a low bit-rate media feed comprises supplying a low bit-rate media feed selected from a group comprising: a commercial advertisement; a highlight video clip; a replay video clip; currently available music; a slide; a video XML stream having a lower bit rate; a media having a less strict audio threshold; a media having a less strict motion threshold; a preloaded educational media; and a media with a reduced amount of feature changes.

13. A device for improving user capacity comprising:
a transmitter having an output;
a receiver having an input; and
a controller coupled to the receiver and the transmitter, the controller programmed to receive at least one operating condition associated with a wireless user at the input of the receiver and supplying a high bit-rate media feed to an end user at the output of the transmitter, the controller further programmed, based upon the at least one operating condition to selectively halt the media feed being made to the end user and thereafter supply a low-bit rate media feed to the end user at the output of the transmitter.

14. The device of claim 13 wherein the at least one operating condition is selected from a group comprising: a Radio Frequency (RF) condition; a system load condition, a battery life of a target mobile station; a signal strength condition; and a mobility condition.

15. The device of claim 13 wherein the low bit-rate media feed is a low-rate media feed.

16. The device of claim 13 wherein the low bit-rate media feed is selected from a group comprising: a commercial advertisement; a highlight video clip; a replay video clip; currently available music; a slide; a video XML stream having a lower bit rate; a media having a less strict audio threshold; a media having a less strict motion threshold; a preloaded educational media; and a media with a reduced amount of feature changes.

17. The device of claim 13 wherein the low bit-rate media feed is media from a play-out buffer having a reduced play-out rate.

18. The device of claim 13 further comprising means for selectively changing a source and rate of the high-rate media.

19. The device of claim 13 wherein the device is positioned at a location, the location being selected from a group comprising: a media broadcaster; a content server, within a radio Access Network (RAN); and a mobile station.
